(19) United States
(12) Patent Application Publication
(10) Pub. No.: US 2008/0197988 A1
(43) Pub. Date: Aug. 21, 2008

(54) VEHICLE WITH PIEZO FIRING SPRING ASSEMBLY

(75) Inventor: John F. Nathan, Highland, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/675,327

(22) Filed: Feb. 15, 2007

(51) Int. Cl. B60Q 1/00

(52) U.S. Cl. 340/436

(57) ABSTRACT

An impulse detector includes a piezoelectric component and a resilient component. The resilient component has a predetermined resistance to deformation during an impact. The piezoelectric component is associated with the resilient component so that an impulse of a predetermined magnitude causes deformation of the piezoelectric component thereby generating a resulting electrical signal. An impulse responsive vehicle seat assembly incorporates the impulse detector to detect vehicle collisions.

### BACKGROUND OF THE INVENTION

1. Field of the Invention

The present invention relates to a piezoelectric impulse detector useful to sensor vehicular impacts. More particularly, the present invention relates to a piezoelectric impulse detector integrated into an impulse responsive vehicle seat assembly.

2. Background Art

Modern automobile design requires compliance with numerous government regulations. In particular, regulations pertaining to automobile safety requirements are replete. Regulations regarding an automobile's response to an impact have been particularly successful in lowering the adverse effects on vehicle occupants. The trend is for newer vehicles to meet even stricter safety requirements.

Recently, regulation FMVSS 202A has been adopted for the design of head restraints. FMVSS 202A is tailored to minimize whiplash injuries during a low speed (10-15 mph) rear-end collision. In such a collision, an occupant's head moves backward and then forward thereby damaging structures in the neck. Front seats must be in compliance with this regulation by Sep. 1, 2008 while rear seats must be in compliance by Sep. 1, 2010.

Although FMVSS 202A places significant design challenges on automobile manufacturers, head restraint design must also address other standards which may appear to be antagonistic to the requirements of FMVSS 202A. For example, the Insurance Institute for Highway Safety (IIHS) places further standards regarding the geometry, positioning, and collision response of head restraints. Although the present head restraint designs work reasonable well, improvements are needed.

Accordingly, improve head restraint designs are needed in order to meet all government safety regulations imposed on automobile design.

### SUMMARY OF THE INVENTION

The present invention solves one or more problems of the prior art by providing in at least one embodiment, an impulse detector for inclusion in an automobile. The impulse detector of this embodiment includes a piezoelectric component and a resilient component. The resilient component has a predetermined resistance to deformation during an impact. The piezoelectric component is associated with the resilient component so that an impulse of a predetermined magnitude causes deformation of the piezoelectric component thereby generating a resulting electrical signal. This electric signal is then used to perform some useful function.

In another embodiment of the present invention, a vehicle seat assembly incorporating the impulse detector set forth above is provided. The vehicle seat assembly of the present embodiment allows a head restraint to be adjusted to a forward position in response to a vehicle collision of sufficient impact. Advantageously, the head restraint of this system is simultaneously able to meet the requirements of FMVSS 202A as well as all other requirements currently imposed on head restraint design.

### BRIEF DESCRIPTION OF THE DRAWINGS

FIG. 1 is a schematic illustration of an automobile system incorporating the impulse detector of an embodiment of the invention;

FIG. 2 is a schematic longitudinal cross-section of a variation of the present invention that uses a spring with a substantially uniform spring constant;

FIG. 3 is a schematic transverse cross-section of the variation of FIG. 2;

FIG. 4 is a schematic longitudinal cross-section of a variation of the present invention that uses a spring having sections with varying spring constants;

FIG. 5 is a schematic longitudinal cross-section of another variation of the present invention that uses a spring in the impulse detector;

FIG. 6 is a schematic longitudinal cross-section of still another variation of the present invention that uses a spring in the impulse detector;

FIG. 7 is a schematic cross-section of an embodiment of the present invention in which an impulse detector is integrated into a vehicle seat assembly;

FIG. 8 is a schematic cross-section of a pelvic catch useable in the vehicle seat assembly of claim 7; and

FIG. 9 is a schematic illustration of an alternative head restraint useable in the vehicle seat assembly of claim 7.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “impulse” as used herein means a force so communicated as to produce a sudden motion.

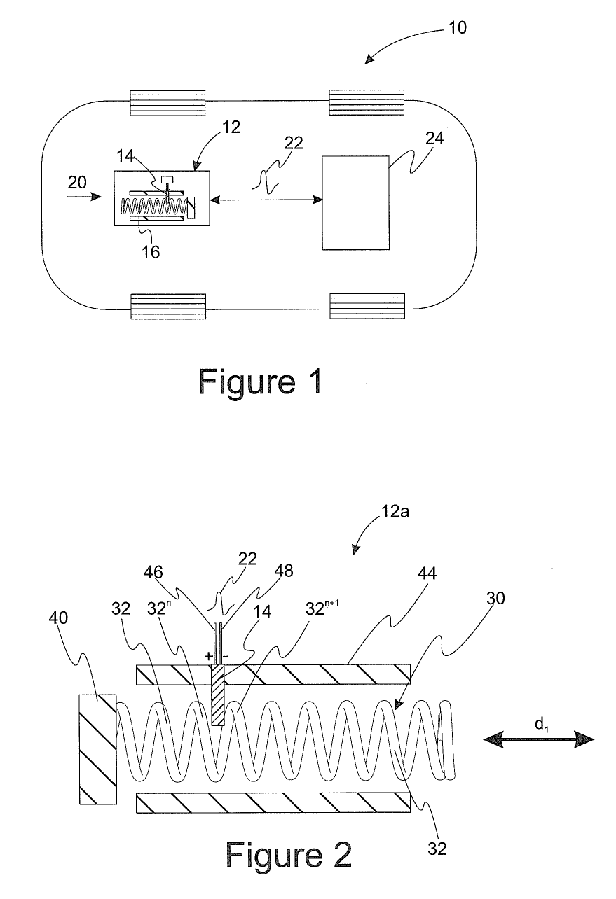

In an embodiment of the present invention, an impulse detector for inclusion in an automobile is provided. With reference to FIG. 1, a schematic illustration of an automobile system incorporating the impulse detector of the present embodiment is provided. Automobile system 10 includes impulse detector 12. Impulse detector 12 includes piezoelectric component 14 and resilient component 16. Collectively, piezoelectric component 14 and resilient component 16 have a predetermined resistance to deformation during an impact. Resilient component 16 is advantageously used to adjust the resistance to deformation. Piezoelectric component 14 is associated with resilient component 16 so that impulse 20 causes deformation of the piezoelectric component 14 with resulting electrical signal 22 being generated. Electrical signal 22 is sent to signal processing subsystem 24 for further processing. The impulse detector system of this embodiment is useful in any application in which the detection of an impulse is useful. Examples include but are not limited to systems for detecting a vehicle collision, movement of a steering wheel, movement of a shifter, and the like. In some applications, impulse detector 12 may be placed in a vehicle seat, a vehicle bumper, a vehicle door, or combinations thereof. In one particularly useful application as set forth in more detail below, impulse detector 12 is in communication with a head restraint actuator.

Resilient component 16 is advantageously used to set the impact characteristics of impulse detector 12. Such characteristics include the magnitude of the impact force necessary to cause a signal sufficient to cause a triggering event (an initiator of some action) for signal processing subsystem 24. In a useful variation, resilient component 16 is a spring. Typically, such springs will have one or more windings. Useful springs may be substantially characterized by a single spring constant or regions of varying spring constants. The spring constant is useful in characterizing the spring's resistance to deformation.

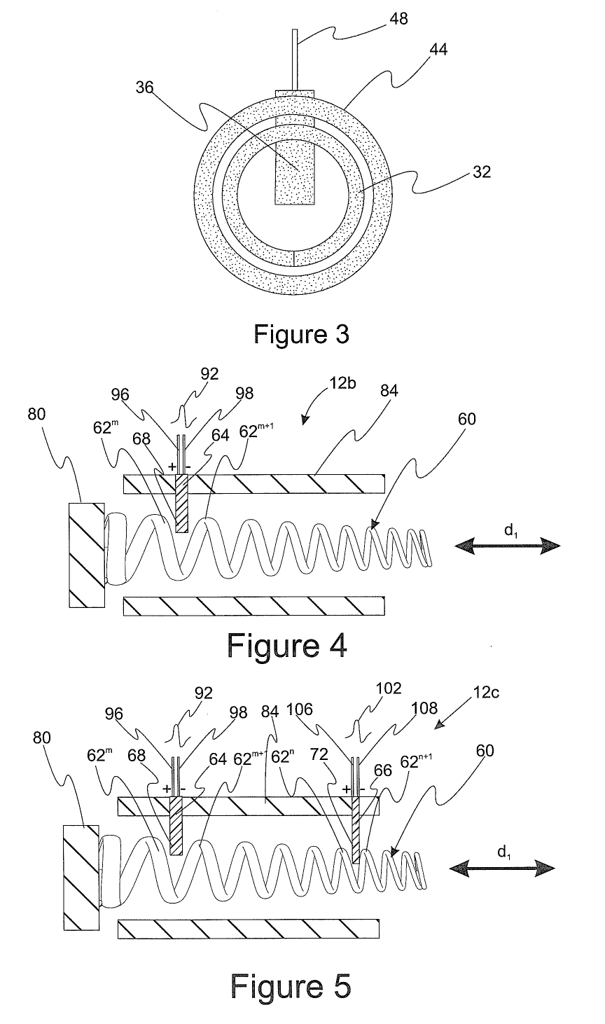

With reference to FIGS. 2 and 3, a variation of the impulse detector utilizing a spring for resilient component 16 is provided. FIG. 2 is a schematic longitudinal cross-section of a variation with a spring with a substantially uniform spring constant. FIG. 3 is a transverse cross-section of this variation. Impulse detector 12a includes spring 30 which has spring windings 32. Portion 36 of the piezoelectric component 14 is interposed between adjacent windings 32ⁿ, 32ⁿ⁺¹. Spring 30 is also attached to base 40. Base 40 remains relatively fixed with respect to the automobile frame. In this manner, spring 30 moves along direction d₁ with respect to base 40 during an impulse. In the specific variation shown in FIGS. 2 and 3, piezoelectric component is attached to supporting structure 44 which also is relatively stationary with respect to the automobile frame. In the example of FIGS. 2 and 3, supporting structure 44 is a cylinder. Impulse signal 22 is generated when an impulse along d₁ causes movement of spring 30 with a resulting deflection of piezoelectric component 14. Signal 22 propagates along cables 46, 48 after being generated. The force necessary to generate signal 22 with a sufficient magnitude and/or duration is at least partially set by the spring constant of spring 30.

With reference to FIG. 4, a variation of the impulse detector in which a spring having sections with varying spring constants is provided. FIG. 4 provides a longitudinal cross-section of this variation. Impulse detector 12b includes spring 60 which has spring windings 62. In this variation, impulse detector 12b includes piezoelectric component 64. Portion 68 of the piezoelectric component 64 is interposed between adjacent windings 62^{m}, 62^{m+1}. Spring 60 is also attached to base 80 at position 82. In this variation, the spring constant decreases as one considers regions on spring 60 further from base 80. Base 80 remains relatively fixed with respect to the automobile frame. In this manner, spring 60 moves along direction d₁ with respect to base 80 during an impulse. In the specific variation shown in FIG. 4, piezoelectric component 64 is attached to supporting structure 84 which also is relatively stationary with respect to the automobile frame. Moreover, in this variation supporting structure 84 is a cylinder. It should be noted that an impulse may cause compression or elongation of spring 60, both of which may generate a signal. Impulse signal 92 is generated when an impulse along d₁ causes movement of spring 60 with a resulting deflection of piezoelectric component 64. Signal 92 propagates along cables 96, 98 after being generated. It should be appreciated that because of the spatially varying spring constant movement of region of relatively low spring constant may not cause generation of a signal of sufficient properties to be used in later processing. This phenomenon is useful in applications such as seat cushions allowing adjustments for comfort while not causing a triggering event.

With reference to FIG. 5, a variation of the present invention in which a spring having sections with varying spring constants is provided. FIG. 4 provides a longitudinal cross-section of this variation. Impulse detector 12c includes spring 60 which has spring windings 62. In this variation, impulse detector 12c includes piezoelectric components 64, 66. Portion 68 of the piezoelectric component 64 is interposed between adjacent windings 62^{m}, 62^{m+1} while portion 72 of the piezoelectric component 66 is interposed between adjacent windings 62ⁿ, 62ⁿ⁺¹. Spring 60 is also attached to base 80 at position 82. In this variation, the spring constant decreases as one considers regions on spring 60 further from base 80. Base 80 remains relatively fixed with respect to the automobile frame. In this manner, spring 60 moves along direction d₁ with respect to base 80 during an impulse. In the specific variation shown in FIG. 4, a piezoelectric component is attached to supporting structure 84 which also is relatively stationary with respect to the automobile frame. Again, supporting structure 84 is a cylinder. Impulse signals 92, 102 are generated when an impulse along d₁ causing movement of spring 60 with a resulting deflection of piezoelectric components 64,66. It should be noted that an impulse may cause compression or elongation of spring 60, both of which may generate a signal. Signal 92 propagates along cables 96, 98 after being generated. Similarly, signal 102 propagates along cables 106, 108 after being generated. It should also be appreciated that because of the spatially varying spring constant of spring 60 an impulse may be only be sufficient to cause one of piezoelectric components 64,66 to generate a sufficient signal for later processing.

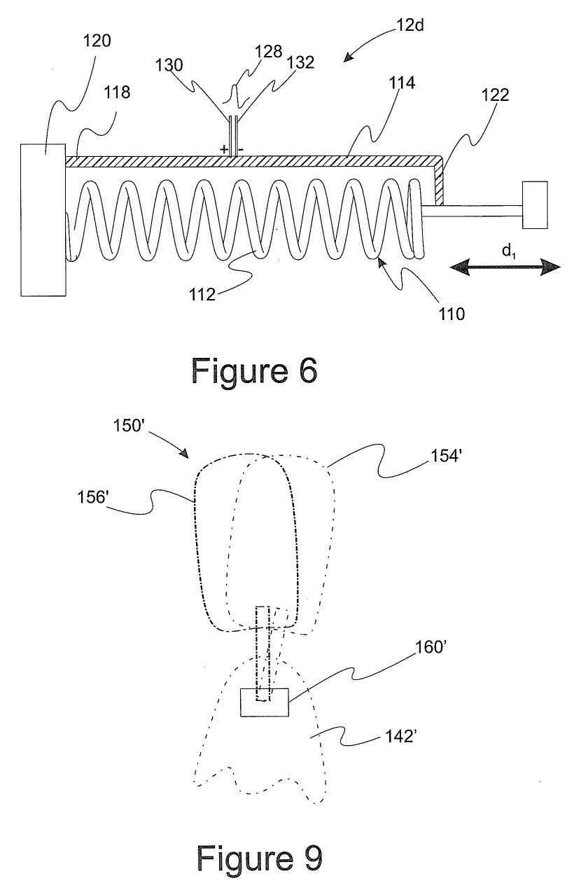

With reference to FIG. 6, another variation of the impulse detector using a spring is provided. FIG. 6 provides a longitudinal cross-section of this variation. Impulse detector 12d includes spring 110 which has spring windings 112. In this variation, impulse detector 12d includes piezoelectric component 114. Section 118 of piezoelectric component 114 is in communication with base 120 which remains relatively fixed with respect to the automobile frame. End 122 of piezoelectric component 114 is in communication with end 124 of spring 110. Spring end 124 is moveable along direction d₁. Impulse signal 128 is generated when an impulse along d₁ causes movement of spring 110 with a resulting deflection of piezoelectric component 114. It should be noted that an impulse may cause compression or elongation of spring 110, both of which may generate a signal. Signal 128 propagates along cables 130, 132 after being generated.

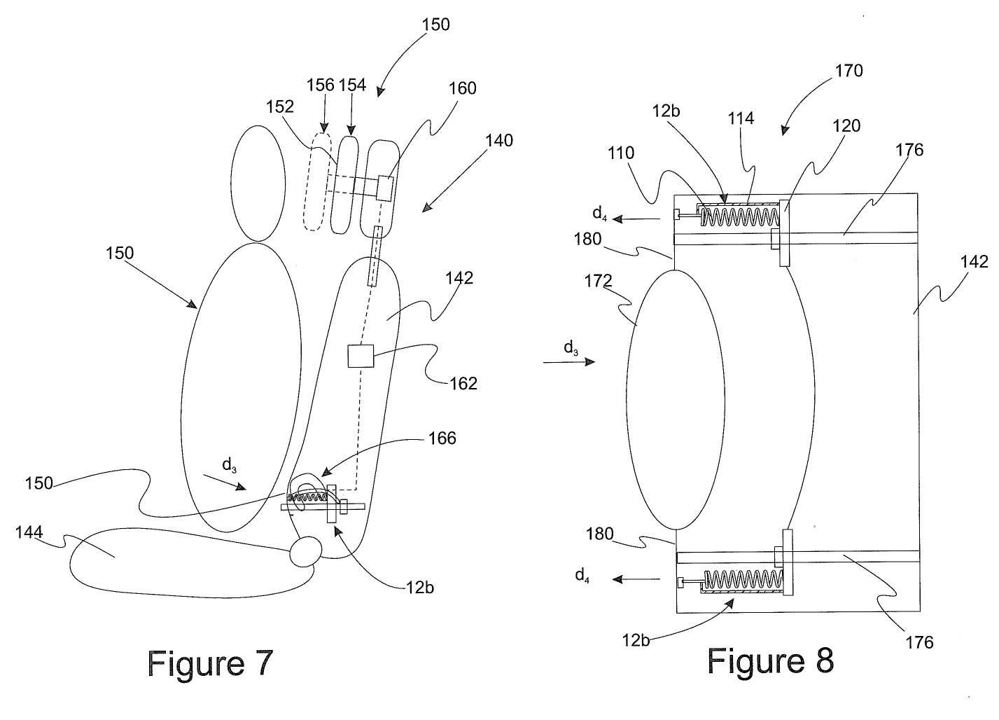

With reference to FIG. 7, a schematic cross-section of an embodiment of the present invention in which an impulse detector is integrated into a vehicle seat is provided. Vehicle seat assembly 140 includes seat back 142 which is proximate to seat bottom 144. Typically, seat back 142 is attached to seat bottom 144. Vehicle seat 140 also includes head restraint 150 which is attached to seat back 142. Head restraint 150 has forward surface 152. Head restraint 150 is adjustable from first configuration 154 to second configuration 156. First configuration 154 has forward surface 152 in a first position while second configuration 156 has forward surface 152 in a second position. The second position is characteristically more forward than the first position. Vehicle seat 140 includes actuator 160 in communication with head restraint 150 via actuator control module 162. Actuator 160 is able to adjust head restraint 150 from first configuration 154 to second configuration 156. Seat back 142 include torso catch 166 which moves upon impact when vehicle occupant 168 is thrust along direction d₃ into seat back 142. This movement is detected by impulse detector 12d which includes a piezoelectric component and a resilient component. Examples of other useful impulse detectors are set forth above. The characteristics of the impulse need to cause adjustment of head restraint 150 from first configuration 154 to second configuration 156 are at least partially determined by the resilient component. Generally, impulses related to normal activities in a vehicle will not cause such adjustment. Instead, impulse typical of a vehicle occupant being thrust into the seat during a collision will cause such an adjustment. In a variation, this impulse will be such that the weight of an average vehicle occupant will cause the adjustment during a rear end collision typically of a whiplash accident (10-15 mph). In other variations, the adjustment will also take place at higher speed collisions. The electrical signal generated by a sufficient impact is at least partially processed by actuator control module 162. If the signal is of sufficient magnitude and duration, actuator control module 162 may cause actuator 160 to adjust from first configuration 154 to second configuration 156. FIG. 7 depicts a vehicle seat assembly that includes an impulse detector of the general design of FIG. 6.

With reference to FIGS. 6, 7, and 8, a schematic of a variation of the pelvic catch used for torso catch 166 of FIG. 7 is provided. Pelvic catch 170 includes cushion section 172 which is mounted within vehicle back 142. Pelvic catch also includes impulse detector(s) 12d. Support rods 176 are used to mount impulse detector(s) 12d. The impulse detector depicted in FIG. 8 of the general design described by FIG. 6. With this detector, impulse detector 12d is mounted onto support rods 176 via block 120. An impulse incident onto pelvic catch 170 along direction d₃ is transmitted to impulse detectors 12d via seat section 180. This causes movement of spring 110 in detector(s) 12d along direction d₄ thereby causing deflection piezoelectric component 114. As set forth above, resilient component 110 has a predetermined resistance to deformation during an impact so that piezoelectric component 114 allowing deformation of the piezoelectric component 114 to generate the electrical signal.

With reference to FIGS. 7 and 9, an alternative embodiment of the head restraint assembly used in FIG. 7 is provided. FIG. 9 provides a schematic illustration of the head restraint of this embodiment. In this variation, head restraint 150′ pivots from first configuration 154′ to second configuration 156′ when sufficient impulse contacts impulse detector 12d as set forth above in connection with the description of FIG. 7. In this variation actuator 160′ incorporated into seat bach 142′ is used to accomplish the pivoting.

In another embodiment of the present invention, a method of responding to a vehicle impact executed by the vehicle seat systems set forth above is provided. The method of this embodiment includes a step in which head restraint 15O is positioned in first configuration 154. In response to an initiating force, a response signal is generated. In some variations, this initiating force is caused by a vehicle impact. The response signal is directed to a actuator control module 160 which in turn causes actuation of actuator 160 such that head restraint 15O is positioned in second configuration 156.

Each of the embodiments and variations of the present invention include a piezoelectric component. In a refinement of the present invention, the piezoelectric component includes piezoelectric ceramic fibers. Examples of such fibers include, but are not limited to, fibers impregnated with, woven with, spun with, or generally including a piezoelectric material. Typically, these fibers are composites of piezoelectric ceramics or other piezoelectric materials. Examples of such materials, include, but are not limited to BaTiO₃, SrTiO₃, Pb(ZrTi)O₃, KNbO₃, LiNbO₃, LiTaO₃, BiFeO₃, Ba₂NaNb₅O₅, Pb₂KNb₅O₁₅, and combinations thereof. Lead zirconate titanate —Pb(ZrTi)O₃— is found to be particularly useful. The formula Pb(ZrTi)O₃ generally refers to Pb[ZrₓTi₁₋ₓ]₃ where 0<x<1. Piezoelectric fibers using in the practice of various embodiments of the invention are commercially available from Advanced Cerametrics Incorporated loced in Lambertville, N.J. In a variation of the present invention, the ceramic fibers are formed as continuous fibers by the Viscose Suspension Spinning Process. In one refinement, this piezoelectric component which itself is non-brittle and has some resiliency. This is useful so that the piezoelectric component not fracture when struck. In another variation, the fibers have an average diameter from about 10 to about 250 microns. In another variation, the fibers have an average Young's Modulus less than about 15×10¹⁰ N/m². In another variation, the fibers have an average Young's Modulus less than about 15×10¹⁰ N/m². In yet another variation, the fibers have an average Young's Modulus less than about 10×10¹⁰ N/m². In yet another variation, the fibers have an average Young's Modulus greater than about 3×10¹⁰ N/m². In still another variation, the fibers have an average Young's Modulus greater than about 5×10¹⁰ N/m².

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An impulse detector for inclusion in an automobile, the impulse detector comprising:
a piezoelectric component; and
a resilient component having a predetermined resistance to deformation during an impact, the piezoelectric component associated with the resilient component so that an impulse of a predetermined magnitude cause deformation of the piezoelectric component thereby generating a resulting electrical signal.

2. The impulse detector of claim 1 wherein the resilient component is a spring.

3. The impulse detector of claim 1 wherein the spring has one or more windings.

4. The impulse detector of claim 1 wherein at least a portion of the piezoelectric component is interposed between adjacent windings of the spring.

5. The impulse detector of claim 1 wherein the piezoelectric component is attached to the resilient component such that the resilient component at least partially imparts resistance to the piezoelectric component.

6. The impulse detector of claim 1 further comprising a base component that remains relatively stationary as compared to the resilient component during the impulse.

7. The impulse detector of claim 1 adapted to be placed in a vehicle seat, a vehicle bumper, a vehicle door, or combinations thereof.

8. The impulse detector of claim 1 in communication with a head restraint actuator.

9. The impulse detector of claim 1 wherein the flexible piezoelectric component comprises piezoelectric ceramic fibers.

10. The impulse detector of claim 9 wherein the flexible piezoelectric component comprises a material selected from the group BaTiO₃, SrTiO₃, Pb(ZrTi)O₃, KNbO₃, LiNbO₃, LiTaO₃, BiFeO₃, Ba₂NaNb₅O₅, Pb₂KNb₅O₁₅, and combinations thereof.

11. An impulse responsive vehicle seat assembly comprising:
a seat bottom;
a seat back proximate to the seat bottom;
a head restraint attached to the seat back, the head restraint having a forward surface, the head restraint being adjustable in a first configuration and a second configuration, the first configuration positioning the forward surface in a first position and the second configuration positioning the forward surface in a second position, the second position being more forward than the first position;
an actuator in communication with the head restraint, the actuator is able to adjust the head restraint from a first configuration to a second configuration; and
an impulse detector comprising:
a piezoelectric component; and
a resilient component having a predetermined resistance to deformation during an impact, the piezoelectric component associated with the resilient component so that an impulse of a predetermined magnitude causes deformation of the piezoelectric component thereby generating a resulting electrical signal that causes the actuator to adjust the head restraint when at least a portion of the flexible piezoelectric component is deflected in a vehicle impact.

12. The vehicle seat assembly of claim 11 wherein the head restraint comprises a forward component and a rear component, the forward component including the forward surface, the forward component moveably attached to the rear component.

13. The vehicle seat assembly of claim 12 wherein the forward component is configured to move forward during the vehicle impact.

14. The vehicle seat assembly of claim 11 wherein the head restraint is pivotably attached to the head restraint.

15. The vehicle seat assembly of claim 11 wherein the head restraint pivots forward during the vehicle impact.

16. The vehicle seat assembly of claim 11 wherein the resilient component comprises a spring.

17. The vehicle seat assembly of claim 11 further comprising a pelvic catch assembly that incorporates the piezoelectric component.

18. The vehicle seat assembly of claim 11 wherein the flexible piezoelectric component comprises piezoelectric ceramic fibers.

19. The vehicle seat assembly of claim 11 wherein the flexible piezoelectric component comprises a material selected from the group BaTiO₃, SrTiO₃, Pb(ZrTi)O₃, KNbO₃, LiNbO₃, LiTaO₃, BiFeO₃, Ba₂NaNb₅O₅, Pb₂KNb₅O₁₅, and combinations thereof.

20. A impulse responsive vehicle seat assembly comprising:
a seat bottom;
a seat back proximate to the seat bottom;
a head restraint attached to the seat back, the head restraint having a forward surface, the head restraint being adjustable in a first configuration and a second configuration, the first configuration positioning the forward surface in a first position and the second configuration positioning the forward surface in a second position, the second position being more forward than the first position;
an actuator in communication with the head restraint, the actuator able to adjust the head restraint from a first configuration to a second configuration;
a pelvic catch assembly comprising a piezoelectric ceramic fiber, the piezoelectric ceramic fiber component being in communication with the actuator, the piezoelectric component generating a signal that causes the actuator to adjust the head restraint when at least a portion of the flexible piezoelectric component is deflected in a vehicle impact.
